(19) United States
(12) Patent Application Publication
(10) Pub. No.: US 2001/0047263 A1
(43) Pub. Date: Nov. 29, 2001

(54) MULTIMODAL USER INTERFACE

(76) Inventors: COLIN DONALD SMITH, OTTAWA (CA); BRIAN FINLAY BEATON, ORLEANS (CA)

Correspondence Address: FINNEGAN, HENDERSON, FARABOW, GARRETT &, DUNNER, 1300 I STREET, N.W., WASHINGTON, DC, 200053315

(21) Appl. No.: 08/992,630

(22) Filed: Dec. 18, 1997

(51) Int. Cl. G10L 11/00; H04M 11/00

(52) U.S. Cl. 704/275; 379/88.15

(57) ABSTRACT

A telecommunications system with multiple modes of interfacing with users. The device accepts, for example, speech or key input and outputs both graphical display data and vocal data. A display at the user site displays various communication options to the user such to call a number, call by name, or look at a directory of names. The user site also includes a voice processor that speaks information reflecting the status of the telecommunication system or reflecting the information on the display.

### RELATED APPLICATIONS

This application is related to U.S. patent application, Ser. No. 08/841,485, entitled ELECTRONIC BUSINESS CARDS; U.S. patent application, Ser. No. 08/842,015, entitled MULTITASKING GRAPHICAL USER INTERFACE; Ser. No. 08/08/841,486, entitled SCROLLING WITH AUTOMATIC COMPRESSION AND EXPANSION; U.S. patent application, Ser. No. 08/842,019, entitled CALLING LINE IDENTIFICATION WITH LOCATION ICON; U.S. patent application, Ser. No. 08/842,017, entitled CALLING LINE IDENTIFICATION WITH DRAG AND DROP CAPABILITY; U.S. patent application, Ser. No. 08/842,020, entitled INTEGRATED MESSAGE CENTER; and U.S. patent application, Ser. No. 08/842,036, entitled IONIZED NAME LIST, all of which were filed concurrently herewith, and all of which are hereby incorporated by reference.

### BACKGROUND OF THE INVENTION

This invention relates generally to the field of telecommunications equipment, and more specifically to the speech and graphical user interfaces for telecommunications equipment that facilitates the entry of input commands.

Telecommunication systems are available with a speech-recognition capability for performing basic tasks such as directory dialing. Additionally, there are network-based speech recognition servers that deliver speech-enabled directory dialing to any telephone. Both of these types of applications use discrete or non-integrated techniques. That is, they use either a graphical interface or a speech interface but not both.

While speech interfaces have been around for a number of years, they have not gained widespread acceptance. Speech interfaces are difficult to use for several reasons. One reason is that the new user has no idea what is acceptable grammar or input vocabulary at any given time in a dialogue. For instance, the user may say “Phone John”, whereas the recognizer may only accept “Call John”, or “Dial John”.

Also, the user often does not know when the recognizer is listening. Users may talk when the recognizer is off, and then become confused when there is no response.

In addition, the best available speech recognizers have recognition performance between 90 and 95 percent under ideal conditions. Generally conditions are not ideal and performance will be affected by, for example, a noisy environment, other speakers, user accents, or a user speaking too softly. With a speech interface, these poor conditions can be handled through additional dialog. The speech recognizer may give the user additional instructions and ask the user to repeat the utterance. Using speech to provide additional information to the user is very slow, especially when multiple options are involved. This can result in a tedious and frustrating interaction.

Generally, speech is fast for input and slow for output. In addition people forget what was said. First, if speech is used to present the user with a list of choices, they will likely have forgotten the first choice before the end of the list is reached. This is a common problem with interactive-voice-response (IVR) applications. Second, if speech is used to give detailed instructions, the user must rely on memory to recall any of the information. Third, users often become ‘lost’ in speech applications because they do not know what level they are at, or what menu items are available.

Therefore, a need exists for a multimodal interface including a combination of speech and graphical interfaces allowing a user to efficiently initiate and complete tasks. The user must be able to easily choose the most efficient means of interacting with the telecommunication system.

### SUMMARY OF THE INVENTION

Systems and methods consistent with the present invention address this need by providing a multimodal user interface that provides a user with more than one input device for efficient entry of commands to a system.

In accordance with the purpose of the invention as embodied and broadly described herein, the multimodal user interface consistent with the principles of the present invention includes a telecommunications system with multiple modes of interfacing with users, including - voice, hard key, touch input, pen input, etc. The device accepts vocal or key input and outputs both graphical display data and vocal data. A display at the user site displays various communication options to the user such to call a number, call by name, or look at a directory of names. The user site also includes a voice processor that speaks information reflecting the status of the system or reflecting the information on the display.

### BRIEF DESCRIPTION OF THE DRAWINGS

The accompanying drawings, which are incorporated in and constitute a part of this specification, illustrate systems and methods consistent with this invention and, together with the description, explain the objects, advantages and principles of the invention. In the drawings,

FIG. 1 is a block diagram of a communications network operating in conjunction with the multitasking graphical user interface consistent with the present invention;

FIG. 2 is a diagram of a user mobile telephone operating in the network of FIG. 1;

FIG. 3 is a block diagram of the elements included in the user mobile telephone of FIG. 2;

FIG. 4 is a block diagram of the software components stored in the flash ROM of FIG. 3;

FIG. 5 is a block diagram of the graphical user interface manager of FIG. 4;

FIGS. 6-9 are flow charts showing steps for processing telecommunication requests according to the present invention;

FIGS. 10a-10f are example screen displays according to the present invention; and

FIG. 11 is an example directory according to the present invention.

### DETAILED DESCRIPTION OF THE PREFERRED EMBODIMENTS

The following detailed description of the invention refers to the accompanying drawings that illustrate preferred embodiments consistent with the principles of this invention. Other embodiments are possible and changes may be made to the embodiments without departing from the spirit and scope of the invention. The following detailed description does not limit the invention. Instead, the scope of the invention is defined only by the appended claims.

The multimodal system of the present invention can be used to overcome a number of the problems with conventional systems. With a multimodal interface, the user can choose the appropriate mode of entering commands at any time in the interaction. The speech modality can be used for fast hands-free and eyes-busy tasks, such as calling a person while driving a car. In a combined speech and graphical interface, graphical feedback could be used to present alternative choices to the user (e.g. best three guesses as to which name the speech recognizer thinks the user wants), display a visual alert to let the user know when to talk and when to listen to the speech recognizer, display text to let the user know are the accepted vocabulary and command words, and to display text and graphics to run new users through a multimedia tutorial.

I. System Architecture

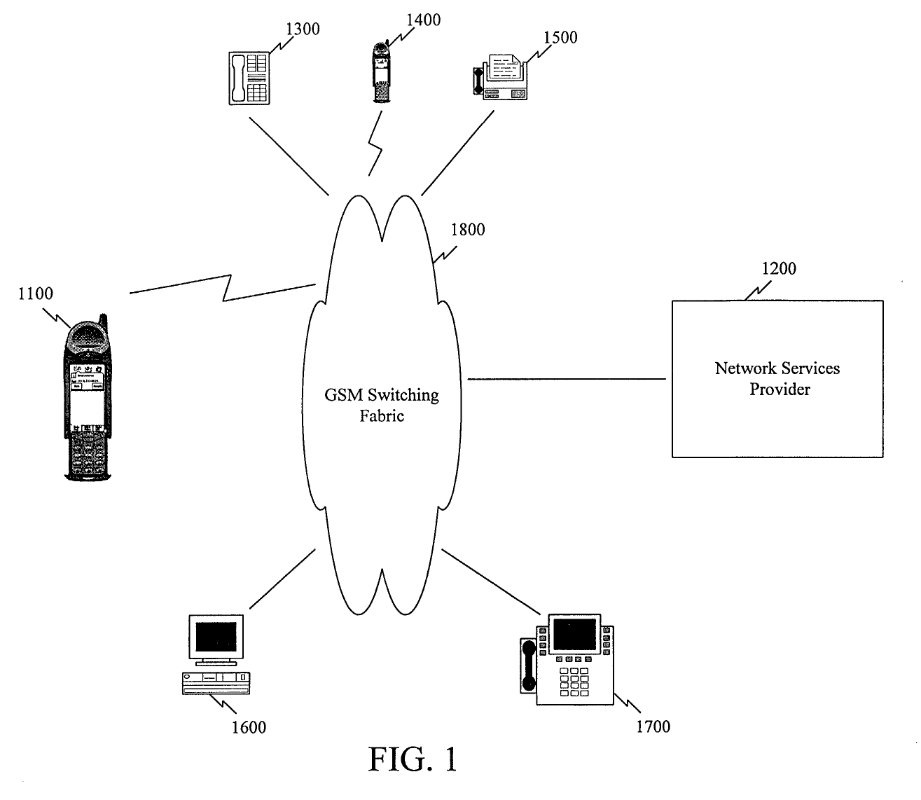

FIG. 1 is a block diagram of a communications network containing mobile telephone 1100 having the multitasking graphical user interface consistent with the present invention. A user communicates with a variety of communication equipment, including external servers and databases, such as network services provider 1200, using mobile telephone 1100.

The user also uses mobile telephone 1100 to communicate with callers having different types of communication equipment, such as ordinary telephone 1300, caller mobile telephone 1400, which is similar to user mobile telephone 1100, facsimile equipment 1500, computer 1600, and Analog Display Services Interface (ADSI) telephone 1700. The user communicates with network services provider 1200 and caller communication equipment 1300 through 1700 over a communications network, such as Global System for Mobile Communications (GSM) switching fabric 1800. The capability of combining voice and digital data transmission is enabled by the GSM protocol which is described in the related applications listed at the beginning of the application.

While FIG. 1 shows caller communication equipment 1300 through 1700 directly connected to GSM switching fabric 1800, this is not typically the case. Telephone 1300, facsimile equipment 1500, computer 1600, and ADSI telephone 1700 normally connect to GSM switching fabric 1800 via another type of network, such as a Public Switched Telephone Network (PSTN).

The user communicates with a caller or network services provider 1200 by establishing either a voice call or a data call. GSM networks provide an error-free, guaranteed delivery transport mechanism by which callers can send short point-to-point messages.

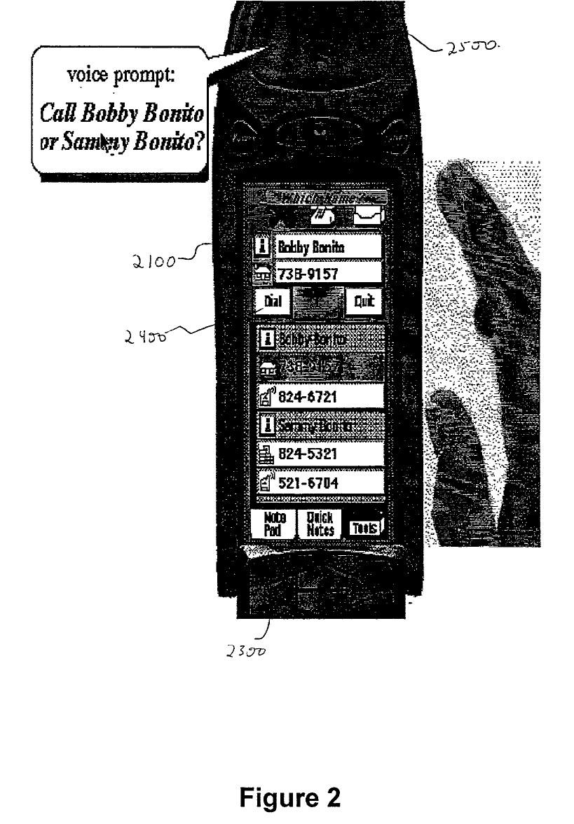

Mobile telephone 1100 provides a user-friendly interface to facilitate incoming and outgoing communication by the user. FIG. 2 is a diagram of mobile telephone 1100 that operates in the network shown in FIG. 1. Mobile telephone 1100 includes main housing 2100, keypad 2300, display 2400, and listening portion 2500.

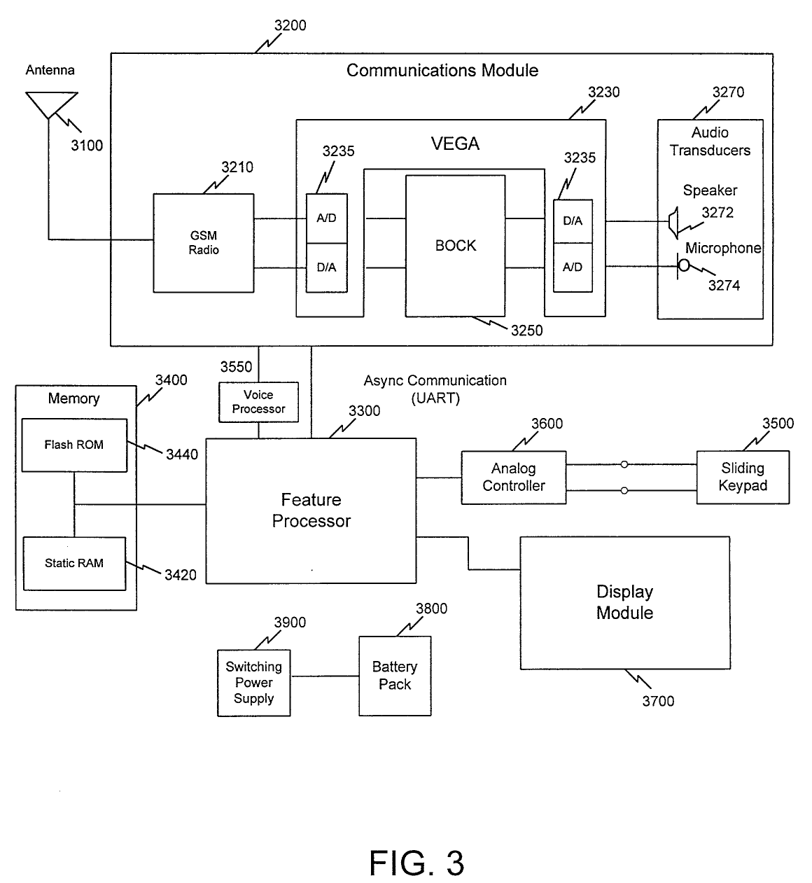

FIG. 3 is a block diagram of the hardware elements in mobile telephone 1100, including antenna 3100, communications module 3200, feature processor 3300, memory 3400, sliding keypad 3500, analog controller 3600, display module 3700, battery pack 3800, and switching power supply 3900.

Antenna 3100 transmits and receives radio frequency information for mobile telephone 1100. Antenna 3100 preferably comprises a planar inverted F antenna (PIFA)-type or a short stub (2 to 4 cm) custom helix antenna. Antenna 3100 communicates over GSM switching fabric 1800 using a conventional voice B-channel, data B-channel, or GSM signaling channel connection.

Communications module 3200 connects to antenna 3100 and provides the GSM radio, baseband, and audio functionality for mobile telephone 1100. Communications module 3200 includes GSM radio 3210, VEGA 3230, BOCK 3250, and audio transducers 3270.

GSM radio 3210 converts the radio frequency information to/from the antenna into analog baseband information for presentation to VEGA 3230. VEGA 3230 is preferably a Texas Instruments VEGA device, containing analog-to-digital (A/D)/digital-to-analog (D/A) conversion units 3235. VEGA 3230 converts the analog baseband information from GSM radio 3210 to digital information for presentation to BOCK 3250.

BOCK 3250 is preferably a Texas Instruments BOCK device containing a conventional ARM microprocessor and a conventional LEAD DSP device. BOCK 3250 performs GSM baseband processing for generating digital audio signals and supporting GSM protocols. BOCK 3250 supplies the digital audio signals to VEGA 3230 for digital-to-analog conversion. VEGA 3230 applies the analog audio signals to audio transducers 3270. Audio transducers 3270 include speaker 3272 and microphone 3274 to facilitate audio communication by the user.

Feature processor 3300 provides graphical user interface features, voice user interface features, and a Java Virtual Machine (JVM). Feature processor 3300 communicates with BOCK 3250 using high level messaging over an asynchronous (UART) data link. Feature processor 3300 contains additional system circuitry, such as a liquid crystal display (LCD) controller, timers, UART and bus interfaces, and real time clock and system clock generators (not shown).

Memory 3400 stores data and program code used by feature processor 3300. Memory 3400 includes static RAM 3420 and flash ROM 3440. Static RAM 3420 is a volatile memory that stores data and other information used by feature processor 3300. Flash ROM 3440, on the other hand, is a non-volatile memory that stores the program code and directories utilized by feature processor 3300.

Sliding keypad 3500 enables the user to dial a telephone number, access remote databases and servers, and manipulate the graphical user interface features. Sliding keypad 3500 preferably includes a mylar resistive key matrix that generates analog resistive voltage in response to actions by the user. Sliding keypad 3500 preferably connects to main housing 2100 (FIG. 2) of mobile telephone 1100 through two mechanical “push pin”-type contacts.

Analog controller 3600 is preferably a Phillips UCB 1100 device that acts as an interface between feature processor 3300 and sliding keypad 3500. Analog controller 3600 converts the analog resistive voltage from sliding keypad 3500 to digital signals for presentation to feature processor 3300.

Voice processor 3550 receives voice commands from a user speaking into microphone 3274. It attempts to decode the command using known voice processing systems and methods.

Display module 3700 is preferably a 160 by 320 pixel LCD with an analog touch screen overlay and an electroluminescent backlight. Display module 3700 operates in conjunction with feature processor 3300 to display the graphical user interface features.

Battery pack 3800 is preferably a single lithium-ion battery with active protection circuitry. Switching power supply 3900 ensures highly efficient use of the lithium-ion battery power by converting the voltage of the lithium-ion battery into stable voltages used by the other hardware elements of mobile telephone 1100.

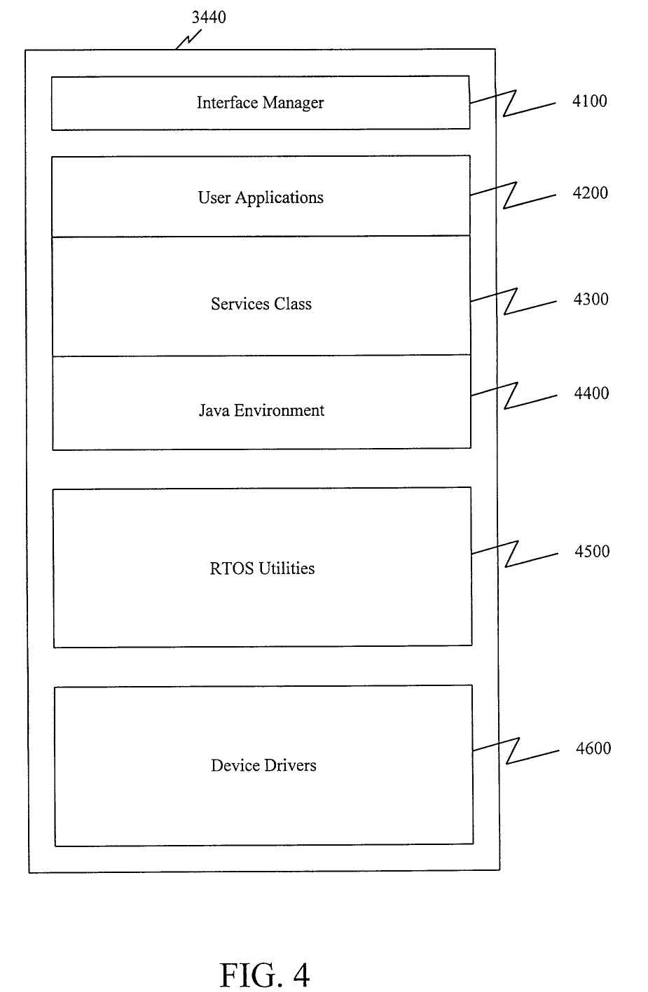

FIG. 4 is a block diagram of the software components of flash ROM 3440, including interface manager 4100, user applications 4200, service classes 4300, Java environment 4400, real time operating system (RTOS) utilities 4500, and device drivers 4600.

Interface manager 4100 acts as an application and window manager. Interface manager 4100 oversees the user interface by allowing the user to select, run, and otherwise manage applications.

User applications 4200 contain all the user-visible applications and network service applications. User applications 4200 preferably include a call processing application for processing incoming and outgoing voice calls, a message processing application for sending and receiving short messages, a directory management application for managing database entries in the form of directories, a web browser application, and other applications.

Service classes 4300 provide a generic set of application programming facilities shared by user applications 4200. Service classes 4300 preferably include various utilities and components, such as a Java telephony application interface, a voice and data manager, directory services, voice mail components, text/ink note components, e-mail components, fax components, network services management, and other miscellaneous components and utilities.

Java environment 4400 preferably includes a JVM and the necessary run-time libraries for executing applications written in the Java™ programming language.

RTOS utilities 4500 provide real time tasks, low level interfaces, and native implementations to support Java environment 4400. RTOS utilities 4500 preferably include Java peers, such as networking peers and Java telephony peers, optimized engines requiring detailed real time control and high performance, such as recognition engines and speech processing, and standard utilities, such as protocol stacks, memory managers, and database packages.

Device drivers 4600 provide access to the hardware elements of mobile telephone 1100. Device drivers 4600 include, for example, drivers for sliding keypad 3500 and display module 3700.

Feature processor 3300 executes the program code of flash ROM 3440 to provide the user friendly interface. Interface manager 4100 controls the graphical user interface and the voice interface. In one embodiment of the present invention, the speech recognition software application is IBM's Voice Type Application for Windows running on a standard Pentium desktop computer. However, other voice processors may be used. The speech recognition software can be either in the device itself or on a network-based server remotely accessed by the device.

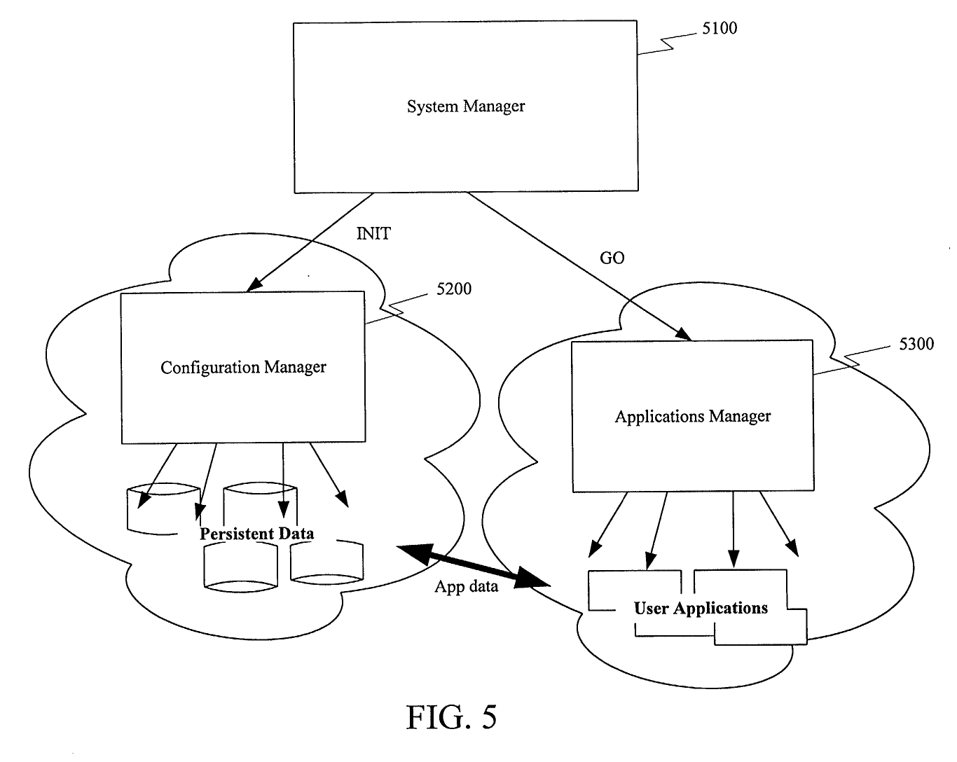

FIG. 5 is a block diagram of interface manager 4100, including system manager 5100, configuration manager 5200, and applications manager 5300. The interface manager uses standard programming languages, such as JAVA, C, or C++ languages.

System manager 5100 acts as a top level manager. Configuration manager 5200 handles the data management for the system. Applications manager 5300 manages user applications 4200. Applications manager 5300 handles the starting and stopping of user visible applications, display access, and window management. Applications manager 5300 provides a common application framework, application and applet security, and class management.

System manager 5100, configuration manager 5200, and applications manager 5300 work together within the framework of interface manager 4100 to provide the environment to allow the user to select, run, and manage user applications 4200 using either a graphical interface or a voice interface. Interface manager 4100 provides a graphical user interface on display 2400 (FIG. 2) from which the user can choose an application to run. Manager 4100 audibly interacts with the user using the voice processor 3550 and the speaker/receiver on the telephone 2100.

II. System Processing

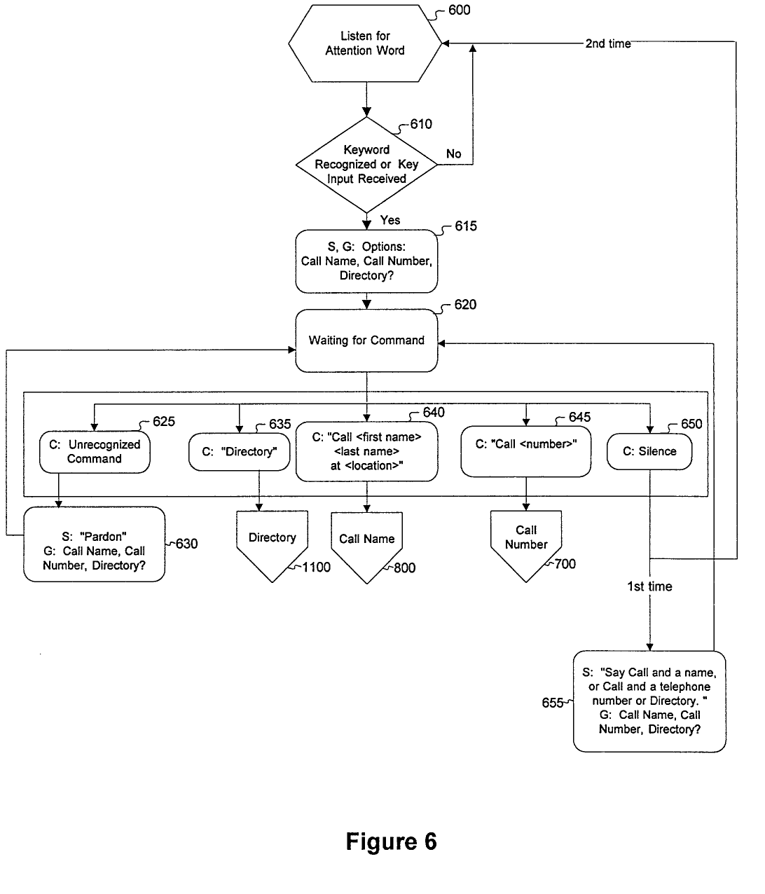

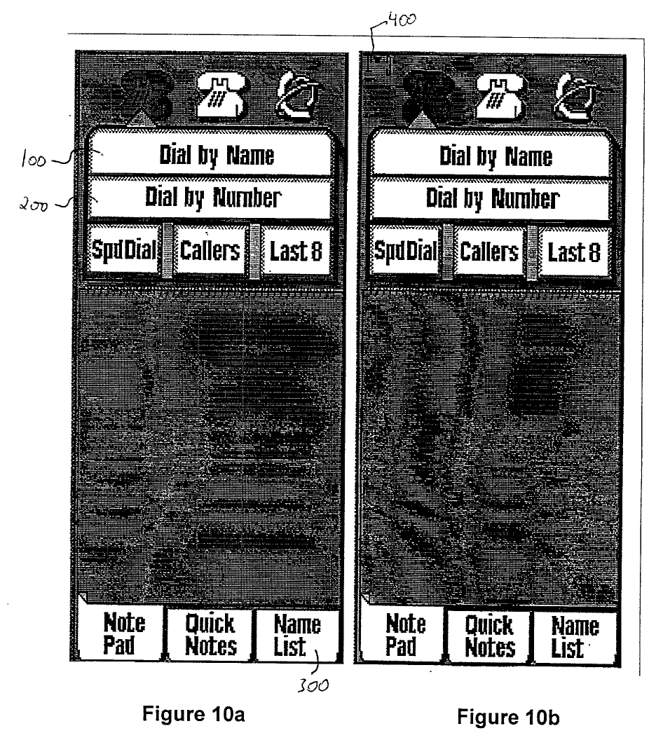

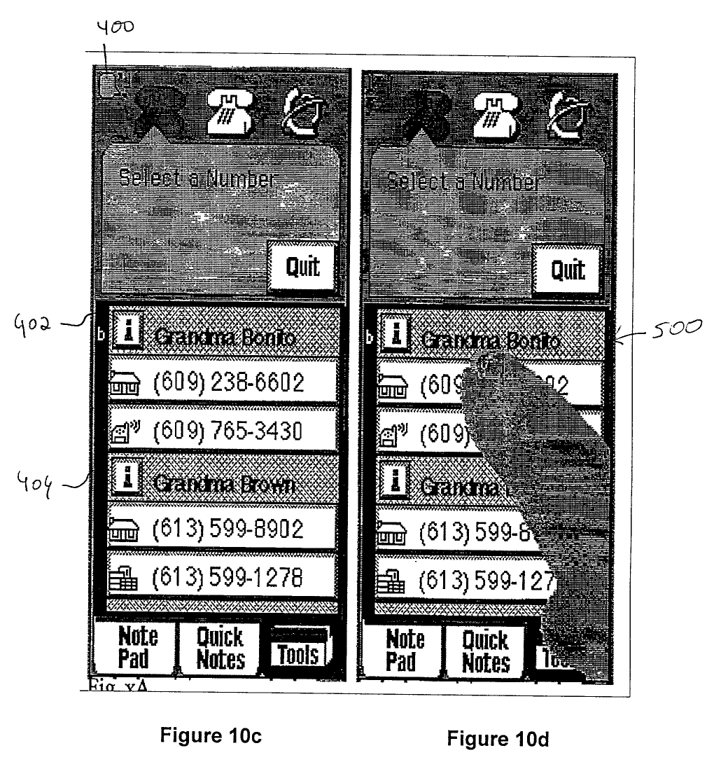

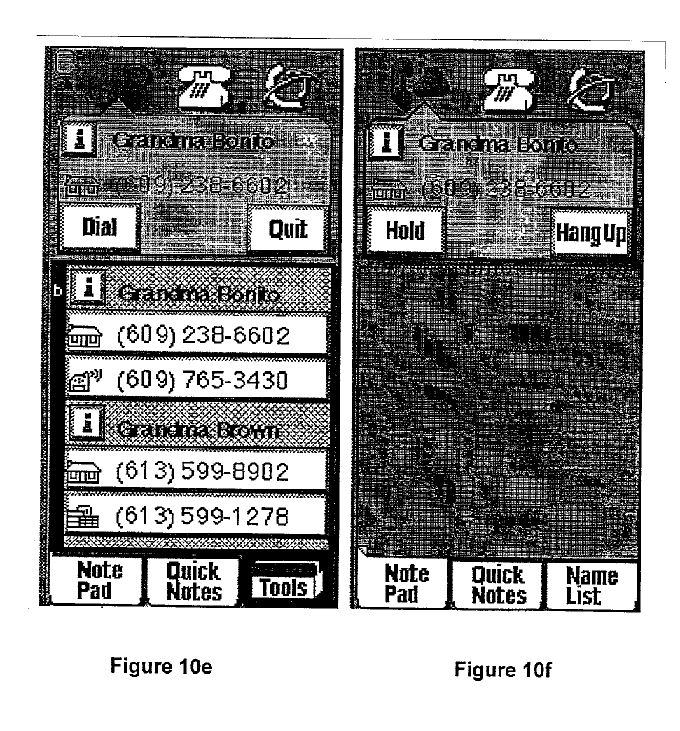

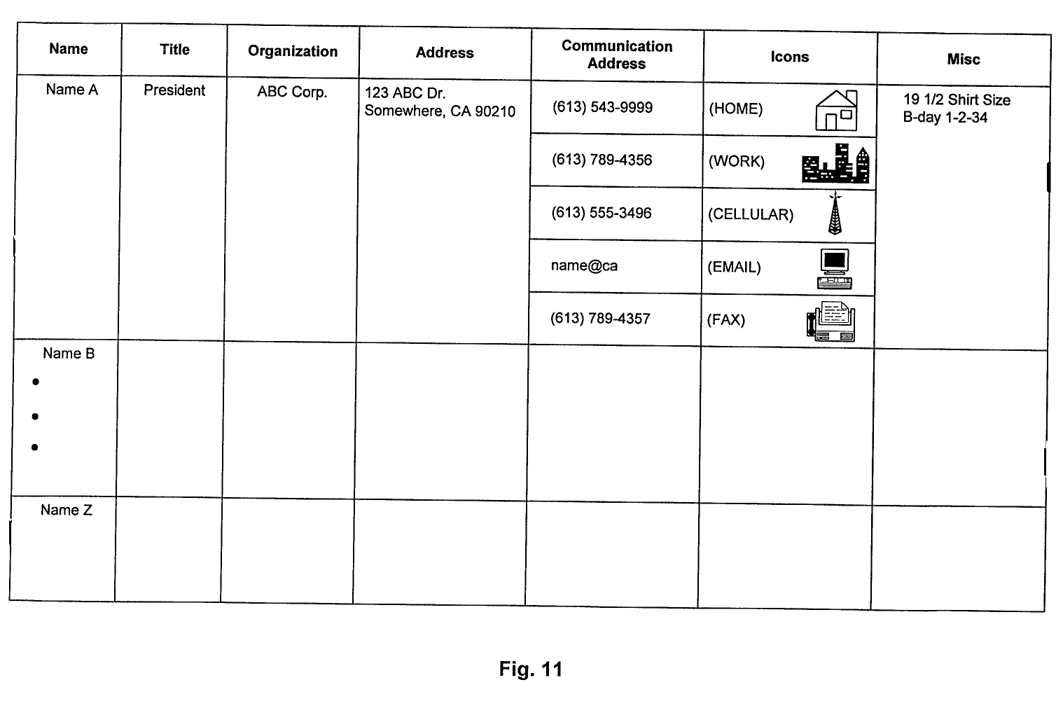

FIGS. 6-9 are flow charts showing steps the interface manager 4100 may perform to carry out methods consistent with the present invention. FIGS. 10a-10f show example screen displays according to one example of the present invention. FIG. 11 shows a directory with called party data.

Systems and methods consistent with the present invention provide both a graphical and voice interface for use to initiate and process telecommunications. A caller may enter commands and data either vocally or using a keypad or some other manual input device. The caller will receive feedback from the telecommunication system both vocally and graphically. This allows the user to choose the most convenient method of interfacing with the telecommunications device.

An embodiment of the present invention will now be described with respect to FIGS. 6-11. The steps in the flow charts include example information for display on display screen 2400 and for vocalization over speaker 3272. All references to display refer to display on screen 2400, all references to voice input refers to microphone 3274 and voice processor 3550, and all references to spoken output refer to speaker 3272. Display information is represented with a “G” for graphical and sound information is represented with “S” for sound. Commands, represented by “C”, may be input by the user using any known input device.

The specifics of what is spoken by the system or what is displayed are merely exemplary. One of ordinary skill in the art would recognize that many different display information or spoken information may be included. In addition, the graphics and or voice may be turned off at the user's convenience. The order of the steps may be altered without affecting the basic system, which allows for a combination of graphical and vocal output and input to allow maximum versatility for the user.

To initiate communications processing consistent with the present invention, an attention word such as “start” is preferably received before any processing will begin. As shown in FIG. 6 the phone system 1100 awaits the attention word or key input before initiating some telecommunication action (step 600). The user may input an attention word or command using any known input device such as verbally into microphone 3274 for processing by voice processor 3550, manually using the keypad 3500 or pressing on a touch sensitive screen.

When the user speaks a word or presses a key (step 605), the system must first recognize the key or the key word as being an attention word/key (step 610). If it is not, the system remains in the state of waiting for the attention word or key input (step 600). Once the key is recognized, the system acknowledges receipt of the key word or key input by an audible sound and the graphical display 2400 will display, and the sound portion 2500 will speak, various choices for the user such as call name, call number, directory (step 615). The directory option refers to reviewing or maintaining a directory of potential called parties, such as is currently known in the art. The system enters a wait state waiting for a command (step 620).

When a command input by the user is not recognizable (step 625), the system notifies the user of this lack of recognition. For example, the system may say “pardon” to the user and display the request to either call name, call number, directory (step 630).

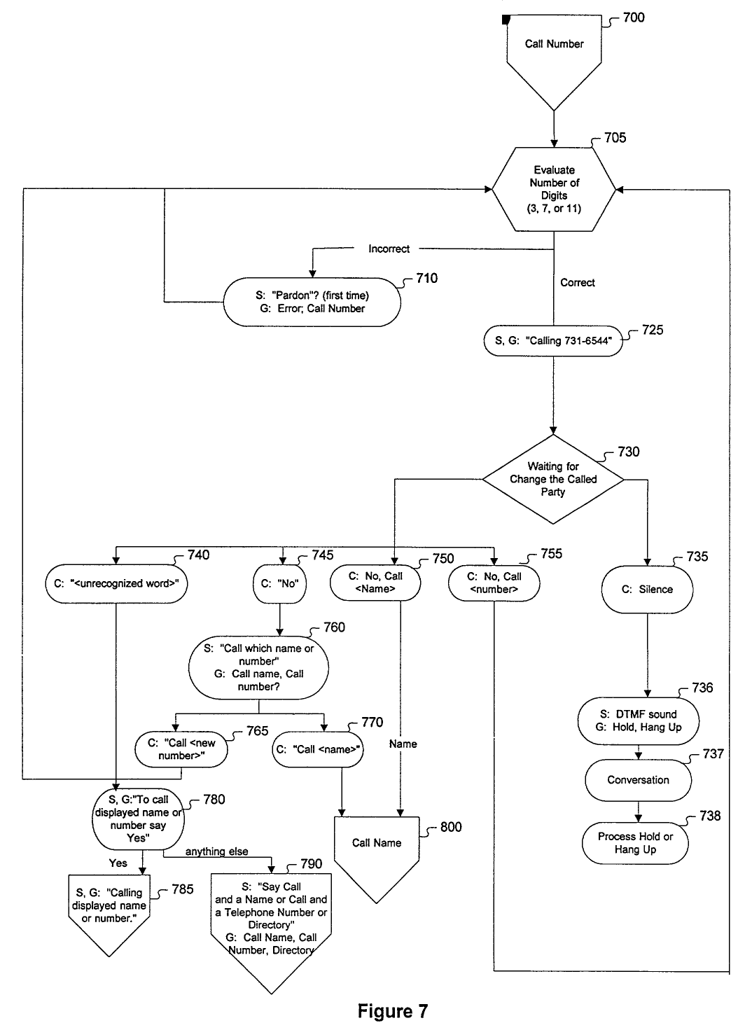

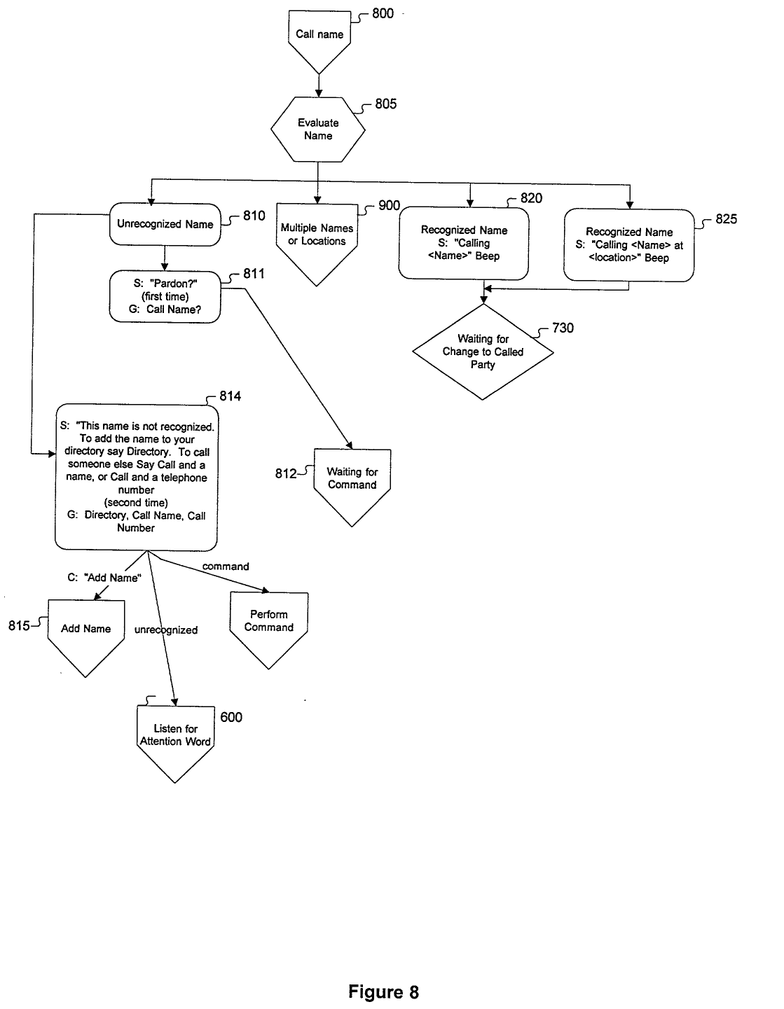

The user may enter a command to call a specific number (step 645), thereby initiating the call number function steps shown in FIG. 7 (step 700). If the user enters a command to call a specific named person (step 640) then the call name function steps shown in FIG. 8 are performed (step 800). When the user enters a command to access a directory (step 635), then the system will perform known directory functions (step 1100).

Typically, the wait state of step 620 will last a predetermined amount of time, such as three seconds, and if no input is received (step 650), the system will display and ask the user verbally to input what type of command they wish to enter such as a command to call a specific name, phone number or to review a directory of names (step 655). Processing then returns to the command wait step 620. However, if no command is input by the user again within the predetermined amount of time (step 650), the system will go back to step 600 and await another attention word or key.

FIG. 7 shows the steps performed by the call number function 700. First, the number of digits entered to be called is evaluated (step 705). There may be several different numbers of digits that are acceptable. For example, for calling an internal number, three digits may be acceptable. For calling a local number, seven digits may be acceptable, and for calling a long distance number, eleven digits may be acceptable. If an incorrect number of digits is entered, the system will verbally state to the user “pardon” and display an error message requesting that the user input a new number (step 710). Processing continues with step 705.

If an acceptable number of digits is entered, the number is called. The system will audibly state to the user that the number entered is being called, and the display will show the number (step 725). Before calling, the system pauses and listens for an indication from the user that he does not wish for the call to proceed (step 730). If the user never requests the change (step 735), the user will hear the DTMF sound of the numbers being dialed, and the system will display during the phone call the choices of selecting to hold or hang up (step 736). The conversation proceeds (step 737) until the user either selects to hold or hang up (step 738).

Returning to step 730, the user may take some action to interrupt the initiation of the phone call. If the user says a word that is not recognized (step 740), the system prompts the user to say whether they wish to call the currently displayed party or number (step 780). If the user says yes, then the procedure of calling the displayed party or number continues (step 785). Otherwise, the system will again state and display the users basic options of call name, call number, or directory (step 790).

If, during the waiting period step 730, the user inputs a new command such as call number, then the call number routine is begun (step 800). If the user inputs a new command to call number, the system restarts processing with step 705. Finally, if the user just gives an indication that this is not the correct number (step 745), the system prompts the user to input a name or number to call (step 760). If the user wishes to call a number (step 765), processing restarts with step 705. If the user wishes to call a name (step 770), processing continues with the call name routine (step 800).

The call name function 800 will be described with respect to FIG. 8. First, the system evaluates the name entered by the user (step 805). To evaluate the name, the system will look to a directory that includes a list of names and numbers and other identifying information. The directory may be stored in memory 3400 or may be on a server on the network. An example directory with directory entries is shown in FIG. 11. As shown, many pieces of information about a party may be stored including the name, title, organization and address. Phone numbers are provided each of the different locations or types of communication devices associated with the party shown in the icons column. This allows a user to direct not only the name of the person to call, but also to where they should be contacted or on which communications device they should be contacted. The directory may be reviewed and edited using known data processing systems.

If a name is not in the directory (step 810) then the system will verbally ask the user to repeat themselves, such as by stating “pardon,” and will graphically request the same information (step 811). The system will then wait for the next user command (step 812). If, after a given number of times, such as three times, the name provided by the user is still not recognized, then the system will verbally request the user to give a different name or to add this person to their directory so that they may call the person (step 814). If the user selects to add the name to a directory then the add name data processing procedure known in the art will be performed (step 815). If the user still says nothing or says the wrong name, the system will return to its initial state of listening for the attention word 600. If the user enters a new command, it is performed (step 816).

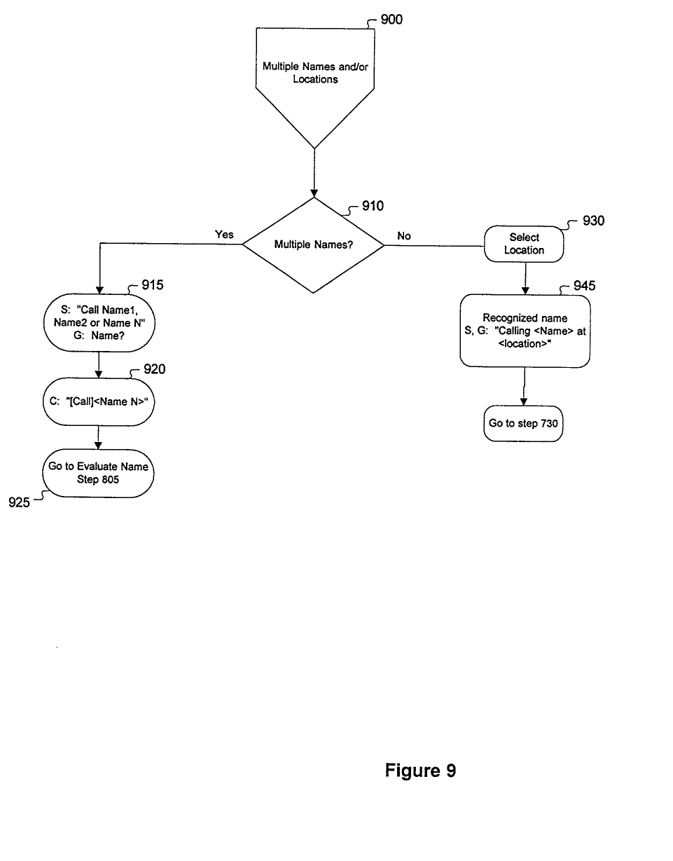

Returning to evaluating step 805, if the user enters multiple names or locations (step 900), the processing will continue with the procedure shown in FIG. 9. If the name is evaluated and recognized, the system will state that it is calling the named person and the graphics will display the same (step 820). When a location is specified along with the called party's name, the system will state that it is calling the named person at a given location and the graphics will display the same (step 825). The user then has a chance to change his or her mind and may enter a change to the displayed called party (step 730). Processing continues as shown in FIG. 7, allowing the user a chance to change the currently displayed called party or to continue processing.

FIG. 9 shows the steps of the function called when a user enters a name that sounds like many others in the directory or when the user enters a name that has a plurality of locations associated with it in the directory. The system determines whether there are multiple names that match or might match that input by the user (step 910). If so, the system asks the user which of the people to call, and the system will display the list of names (step 915). If the user enters the command to call a specific name (step 920), the system will continue processing by going to step 820 (step 925).

If there are not multiple names (step 910), then there are multiple locations in the directory for the names party . Therefore, the system displays a list stored in the directory from which the user may select a location to call the party (step 930). The system will then audibly state that it is calling a specific name at a specific location, and the same is displayed (step 945). Processing continues with step 730 as shown in FIG. 7.

FIGS. 10a-10f show example screen displays according to the present invention. FIG. 10a shows the basic screen display with the users selections to dial by name 100 or by number 200. The name list selection 300 allows the user to view the directory of names, such as the directory shown in FIG. 11. After an attention word is entered into the system, icon 300 shown in FIG. 10b is displayed on the screen to indicate to the user that the system is on and waiting for a command. Throughout processing the telephone call, icon 300 is displayed whenever it is time for user input.

Icon 400 shown in FIG. 10c indicates to the user that the system is providing display and vocal output. In this sample screen display, the user input the command to call grandma and the system is displaying the two entries 402, 404 in the directory that match the request. FIG. 10d shows the user touching the touch sensitive screen 500 to select one grandma. FIG. 10e shows an example display showing the name and number of the currently being called party. FIG. 10f shows the screen displayed to the user after connection with the called party. As shown, the user may select to place the called party on hold or hangup.

III. Conclusion

The combined speech and graphical user interface consistent with the principles of the present invention provides a simple interaction model by which a user can select and operate communication tasks with ease.

The foregoing description provides illustration and description, but is not intended to be exhaustive or to limit the invention to the precise form disclosed. Modifications and variations are possible in light of the above teachings or may be acquired from practice of the invention.

Additionally, the foregoing description detailed specific graphical user interface displays, containing various graphical icons and buttons. These displays have been provided as examples only. The foregoing description encompasses obvious modifications to the described graphical user interface displays. The scope of the invention is defined by the claims and their equivalents.

What is claimed is:

1. A communication unit comprising:
means for displaying communication information prompting a caller for input;
means for speaking audio communications reflecting the displayed information; and
means for receiving vocal or manual data input from a caller providing a communication request.

2. The unit according to claim 1, wherein the means for displaying includes:
means for showing a plurality of communication options on a visual display; and
wherein the means for speaking includes
means for vocally identifying the plurality of options.

3. The unit according to claim 2 further including
means for receiving a selection of one of the displayed options; and
means for vocally repeating the plurality of selections when no selection is received within a predetermined amount of time.

4. The unit according to claim 2 wherein the means for receiving vocal or manual data includes
means for recognizing a vocal command; and
means for requesting the caller to repeat the vocal command when the recognizing means does not recognize the vocal command.

5. The unit according to claim 4, further including
means for maintaining a directory of potential called parties, the directory maintaining both a vocal version of the name, the text of the name, and the telephone number associated with the name.

6. The unit according to claim 5 further including
means for adding a name to the directory.

7. The unit according to claim 6 further including
means for receiving a command to call a party with a specific name;
means for searching the directory for the specific name and calling a number associated with the specific name in the directory.

8. The unit according to claim 7 further including
means for maintaining in the directory a plurality of telephone numbers associated with a single name, each of the telephone numbers corresponding to a different identified location; and
means for receiving a name and location of a called party.

9. The unit according to claim 2 further including
means for receiving a name of a party to call; and
means for dialing a number associated with the received name.

10. The unit according to claim 9 further including:
means for displaying a name of a called party currently being dialed;
means for receiving an indication to end the current call; and
means for disconnecting the telephone in response to receiving the indication.

11. The unit according to claim 2 further including
means for receiving a number to call; and
means for dialing the number.

12. The unit according to claim 11 further including
means for displaying a number currently being dialed;
means for receiving an indication to end the current call; and
means for disconnecting the telephone in response to receiving the indication.

13. A method of interfacing with a communication unit comprising the steps of
displaying communication information prompting a caller for input;
speaking audio communications reflecting the displayed information; and
receiving vocal or manual data input from a caller providing a communication request.

14. The method according to claim 13, wherein the step of displaying includes the step of showing a plurality of communication options on a visual display; and wherein the step of speaking includes the step of vocally identifying the plurality of options.

15. The method according to claim 14 further including the steps of
receiving a selection of one of the displayed options; and
vocally repeating the plurality of selections when no selection is received within a predetermined amount of time.

16. The method according to claim 14 wherein the step of receiving vocal or manual data includes the steps of
recognizing a vocal command; and
requesting the caller to repeat the vocal command when the command is not recognized.

17. The method according to claim 16, further including the step of
maintaining a directory of potential called parties, wherein the directory maintains both a vocal version of the name, the text of the name, and the telephone number associated with the name.

18. The method according to claim 17 further including the steps of
receiving a command to call a party with a specific name;
searching the directory for the specific name and calling a number associated with the specific name in the directory.

19. The method according to claim 18 further including the step of maintaining in the directory a plurality of telephone numbers associated with a single name, wherein each of the telephone numbers corresponds to a different identified location; and
receiving a name and location of a called party.

20. The method according to claim 14 further including the steps of
receiving a name of a party to call; and
dialing a number associated with the received name.

21. The method according to claim 20 further including the steps of
displaying a name of a called party currently being dialed;
receiving an indication to end the current call; and
disconnecting the telephone in response to receiving the indication.

22. The method according to claim 14 further including the steps of
receiving a number to call; and
dialing the number.

23. The method according to claim 22 further including
displaying a number currently being dialed;
receiving an indication to end the current call; and
disconnecting the telephone in response to receiving the indication.

24. A communication network comprising:
user communication site including
means for displaying communication information prompting a caller for input;
means for speaking audio communications reflecting the displayed information; and
means for receiving vocal or manual data input from a caller providing a communication request; and
network communication site including
means for performing the communication request.

25. The network according to claim 24, wherein the means for displaying includes:
means for showing a plurality of communication options on a visual display; and
wherein the means for speaking includes
means for vocally identifying the plurality of options.

26. The network according to claim 25 wherein the network site further includes
means for receiving a selection of one of the displayed options; and
means for performing the selected option.

27. The network according to claim 24, said user site further including
means for maintaining a directory of potential called parties, the directory maintaining both a vocal version of the name, the text of the name, and the telephone number associated with the name.

28. The network according to claim 24, said network site further including
means for maintaining a directory of potential called parties, the directory maintaining both a vocal version of the name, the text of the name, and the telephone number associated with the name.

29. The network according to claim 28 further including
means for receiving a command to call a party with a specific name;
means for searching the directory for the specific name and calling a number associated with the specific name in the directory.

30. The network according to claim 28 further including
means for maintaining in the directory a plurality of telephone numbers associated with a single name, each of the telephone numbers corresponding to a different identified location; and
means for receiving a name and location of a called party.
